(19) United States
(12) Patent Application Publication
(10) Pub. No.: US 2008/0084467 A1
(43) Pub. Date: Apr. 10, 2008

(54) Connection member, electric substrate, optical scanning device, and image forming apparatus

(75) Inventors: Keiichi Satou, Saitama (JP); Yasuo Yoshida, Saitama (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/822,505

(22) Filed: Jul. 6, 2007

(30) Foreign Application Priority Data
Oct. 10, 2006 (JP) 2006-276365

(51) Int. Cl. B41J 2/00; H01R 13/642

(52) U.S. Cl. 347/132; 439/377

(57) ABSTRACT

A connection member that connects an electric substrate and a light source that emits a light beam, the connection member comprising: a light source terminal insertion portion into which a light source terminal of the light source is inserted from one end portion side and having another end portion side that penetrates the electric substrate.

### CROSS-REFERENCE TO RELATED APPLICATION

This application is based on and claims priority under 35 USC 119 from Japanese Patent Application No. 2006-276365 filed on Oct. 10, 2006.

### BACKGROUND

1. Technical Field

The present invention relates to a connection member, an electric substrate, an optical scanning device, and an image forming apparatus.

2. Related Art

In an optical scanning device, a laser diode and an electric substrate are connected to each other by passing pins of the laser diode through attachment holes that penetrate the electric substrate and soldering them.

However, when the laser diode and the electric substrate are directly soldered in this manner, the laser diode and the electric substrate cannot be easily separated when defects such as damage to the laser diode or the electric substrate resulting from solder defects occur, and it is difficult to recycle them.

### SUMMARY

According to an aspect of the invention, there is provided: a connection member that connects an electric substrate and a light source that emits a light beam, the connection member comprising: a light source terminal insertion portion into which a light source terminal of the light source is inserted from one end portion side and whose other end portion side penetrates the electric substrate.

### BRIEF DESCRIPTION OF THE DRAWINGS

An exemplary embodiment of the present invention will be described in detail based on the following figures, wherein:

FIG. 1 is a diagram showing the overall configuration of an image forming apparatus to which the exemplary embodiment is applied;

FIG. 2 is a longitudinal sectional diagram showing the internal configuration of an optical scanning device;

FIG. 3 is a plan diagram showing the internal configuration of the optical scanning device;

FIG. 4 is a schematic diagram showing laser light beams being reflected in a horizontal direction by a rotating polygon mirror;

FIG. 5 is a configural diagram partially showing, in an enlarged cross section, the vicinity of an attachment portion to which laser light sources are attached;

FIG. 6 is a schematic configural diagram showing light paths of the laser light beams;

FIG. 7 is a perspective diagram showing a socket;

FIG. 8A is a top diagram showing the socket;

FIG. 8B is a side diagram showing the socket;

FIG. 8C is a front diagram showing the socket;

FIG. 9A is a top diagram showing a connection pin of the socket;

FIG. 9B is a front diagram showing the connection pin of the socket;

FIG. 10 is a cross-sectional diagram of an electric substrate to which the socket is connected;

FIG. 11A is a diagram showing the electric substrate being slid;

FIG. 11B is a diagram showing terminals of the laser light source being inserted into the socket;

FIG. 11C is a diagram showing the laser light source being connected to the electric substrate;

FIG. 12 is a perspective diagram of the electric substrate to which the sockets are connected;

FIG. 13 is a plan diagram of the electric substrate to which the sockets are connected;

FIG. 14 is a perspective diagram showing a socket of a first modification;

FIG. 15A is a top diagram showing the socket of the first modification;

FIG. 15B is a side diagram showing the socket of the first modification;

FIG. 15C is a front diagram showing the socket of the first modification;

FIG. 16A is a top diagram showing a connection pin of the socket of the first modification;

FIG. 16B is a front diagram showing the connection pin of the socket of the first modification;

FIG. 16C is a side diagram showing the connection pin of the socket of the first modification;

FIG. 17 is a diagram showing a plate spring portion of the connection pin of the first modification;

FIG. 18 is a diagram showing an aperture portion of a connection pin of a socket of another example of the first modification;

FIG. 19 is a cross-sectional diagram showing a laser light source connected to an electric substrate to which a socket of a second modification is connected;

FIG. 20A is a diagram showing the process of folding the pins of the laser light source;

FIG. 20B is a diagram showing the process of folding the pins of the laser light source;

FIG. 20C is a diagram showing the process of folding the pins of the laser light source;

FIG. 21 is a plan diagram of a surface disposed with a drive circuit of the electric substrate to which the socket is connected; and

FIG. 22 is a cross-sectional diagram showing a laser light source connected to an electric substrate to which a socket of a third modification is connected.

### DETAILED DESCRIPTION

An exemplary embodiment of the present invention will be described in detail below with reference to the attached drawings.

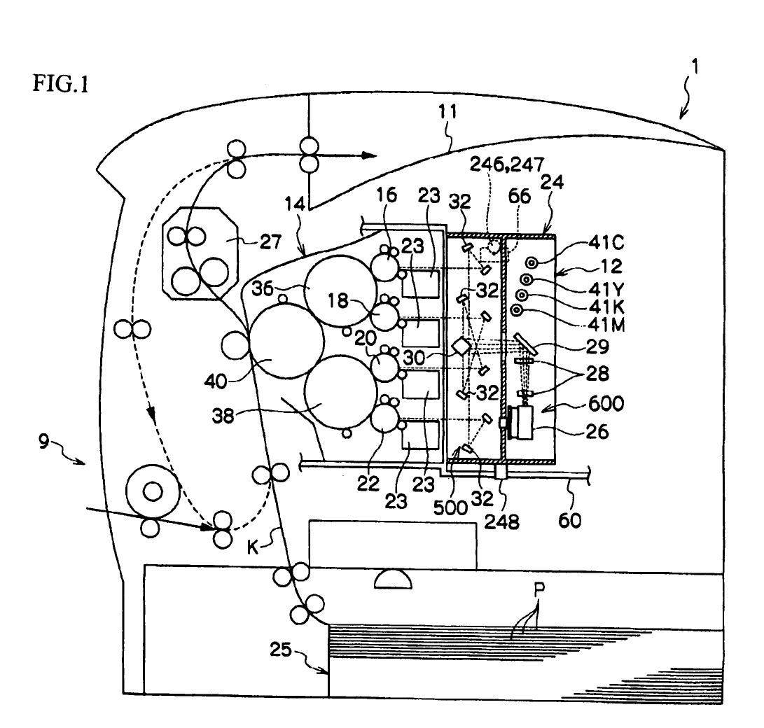

FIG. 1 is a schematic configural diagram of an image forming apparatus 1 pertaining to the present exemplary embodiment.

The image forming apparatus 1 is configured as a tandem full-color printer, and disposed inside a body 9 of the image forming apparatus 1 are an optical scanning device 12 and a print head device 14 that is an image forming unit that performs full-color image formation.

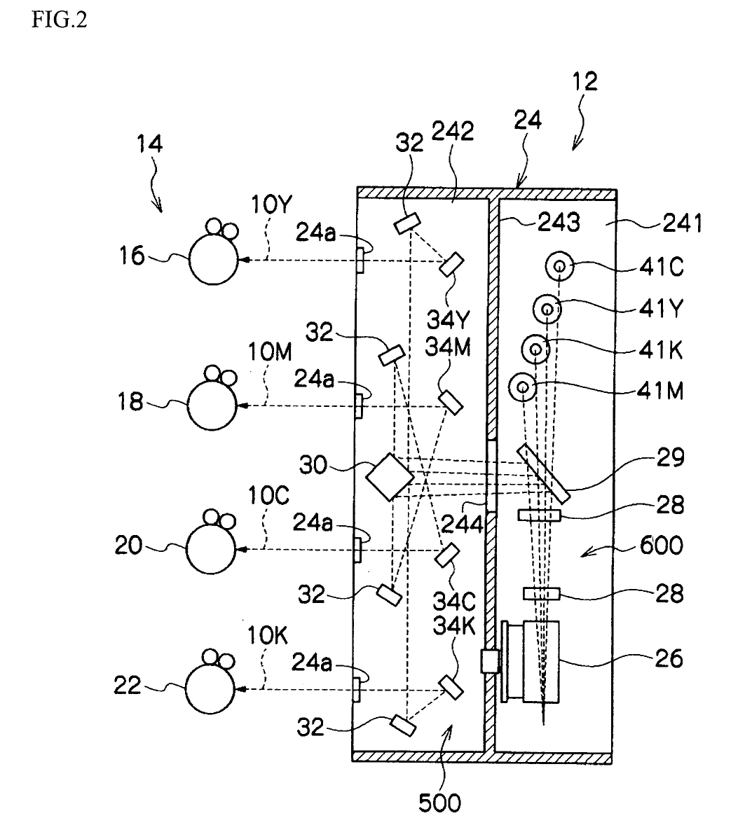

The optical scanning device 12 is disposed with an optical box (housing) 24. Disposed inside the optical box 24 are a rotating polygon mirror (rotating reflection mirror, polygon mirror) 26, scanning lenses (fθ lenses) 28, a folding mirror 29, a split polygon mirror (split mirror, splitting portion) 30, reflection mirrors 32, and cylindrical mirrors (optical elements) 34Y, 34M, 34C and 34K (see FIG. 2). Also disposed inside the optical box 24 are laser light sources 41Y, 41M, 41C and 41K that emit laser light beams 10Y to 10K (see FIG. 2).

Dustproof windows 24a (see FIG. 2) are disposed in the optical box 24. The laser light beams 10Y to 10K (see FIG. 2) are transmitted through the dustproof windows 24a (see FIG. 2) and made incident on four photosensitive drums 16, 18, 20 and 22 serving as image carriers.

In this manner, the optical scanning device 12 is configured to perform image exposure processing with respect to the four photosensitive drums 16, 18, 20 and 22.

The print head device 14 is disposed with the four photosensitive drums 16, 18, 20 and 22 serving as image carriers corresponding to the respective colors of yellow (Y), magenta (M), cyan (C) and black (K). Each of the photosensitive drums 16, 18, 20 and 22 includes a developing device 23.

The print head device 14 is disposed with plural intermediate transfer bodies 36, 38 and 40. That is, the print head device 14 is disposed with an intermediate transfer body 36 to which toner images formed on the photosensitive drums 16 and 18 are multiply transferred, an intermediate transfer body 38 to which toner images formed on the photosensitive drums 20 and 22 are multiply transferred, and an intermediate transfer body 40 to which the multiple toner images of the intermediate transfer bodies 36 and 38 are further multiply transferred.

A paper supply cassette 25 in which recording paper (sheets) P is stored is disposed in a lower portion of the body 9 of the image forming apparatus 1. A conveyance path K on which the recording paper P is conveyed is formed leading upward from the paper supply cassette 25. The intermediate transfer body 40 of the print head device 14 and a fixing device 27 are disposed in the middle of the conveyance path K. Further, disposed in an upper surface of the body 9 is a discharge tray 11 into which the recording paper P to which the toner image has been fixed by the fixing device 27 is discharged.

In the image forming apparatus 1 configured in this manner, the laser light beams 10Y to 10K (see FIG. 2) from the optical scanning device 12 are made incident on the corresponding photosensitive drums 16, 18, 20 and 22, whereby electrostatic latent images are formed on the surfaces of the photosensitive drums 16, 18, 20 and 22. Thereafter, the electrostatic latent images are developed by the developing devices 23, whereby toner images of the respective colors are formed on the photosensitive drums 16, 18, 20 and 22. Then, the yellow toner image formed on the photosensitive drum 16 and the magenta toner image formed on the photosensitive drum 18 are sequentially transferred to the intermediate transfer body 36 conveyed in one direction at a constant speed. Further, the cyan toner image formed on the photosensitive drum 20 and the black toner image formed on the photosensitive drum 22 are sequentially transferred to the intermediate transfer body 38 conveyed in one direction at a constant speed.

Thereafter, the toner images on the intermediate transfer bodies 36 and 38 are finally transferred to the intermediate transfer body 40 and then collectively transferred to the recording paper P supplied from the paper supply cassette 25. Thus, a full-color toner image can be obtained. The full-color toner image that has been transferred to the recording paper P is fixed to the recording paper P by the fixing device 27, and then the recording paper P is discharged into the discharge tray 11 in the upper surface of the body 9.

Next, the optical scanning device 12 will be described in greater detail.

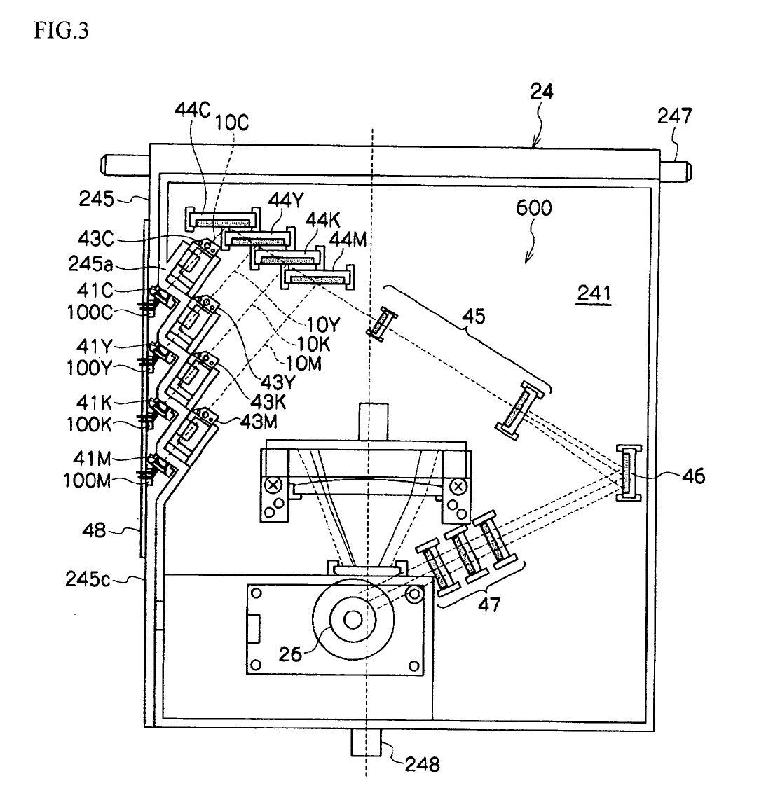

FIG. 2 and FIG. 3 are configural diagrams showing the internal configuration of the optical scanning device 12. Specifically, FIG. 2 is a longitudinal sectional diagram showing the internal configuration of the optical scanning device 12, and FIG. 3 is a plan diagram showing the internal configuration of the optical scanning device 12.

The optical box 24 of the optical scanning device 12 is configured to have a dustproof structure. Additionally, the optical box 24 includes a first case 241 and a second case 242. That is, the space inside the optical box 24 is partitioned by a boundary portion 243, and the first case 241 and the second case 242 that have individual spaces are formed by the boundary portion 243. A window 244 that spatially interconnects the first case 241 and the second case 242 is disposed in the boundary portion 243. Further, the first case 241 includes a side wall 245 (the side wall 245 configures a side surface in a width direction orthogonal to the conveyance direction of the recording paper P).

A first optical system 600 is disposed in the first case 241, and a second optical system 500 is disposed in the second case 242. It will be noted that the first optical system 600 and the second optical system 500 can also be called imaging optical systems.

The first optical system 600 is disposed with the laser light sources 41Y, 41M, 41C and 41K. The laser light sources 41Y, 41M, 41C and 41K are attached to an attachment portion 245a formed on the side wall 245 of the first case 241. The attachment portion 245a of the side wall 245 extends so as to intersect the side wall 245 at a predetermined angle. That is, the attachment portion 245a is formed in a stepped shape such that the laser light beams 10Y, 10M, 10C and 10K generated by the laser light sources 41Y, 41M, 41C and 41K progress in a diagonal direction with respect to the side wall 245 and such that the four laser light beams 10Y to 10K progress parallel to each other.

The laser light sources 41Y, 41M, 41C and 41K are respectively driven by yellow (Y), magenta (M), cyan (C) and black (K) image signals and emit the laser light beams 10Y to 10K that become divergent light beams.

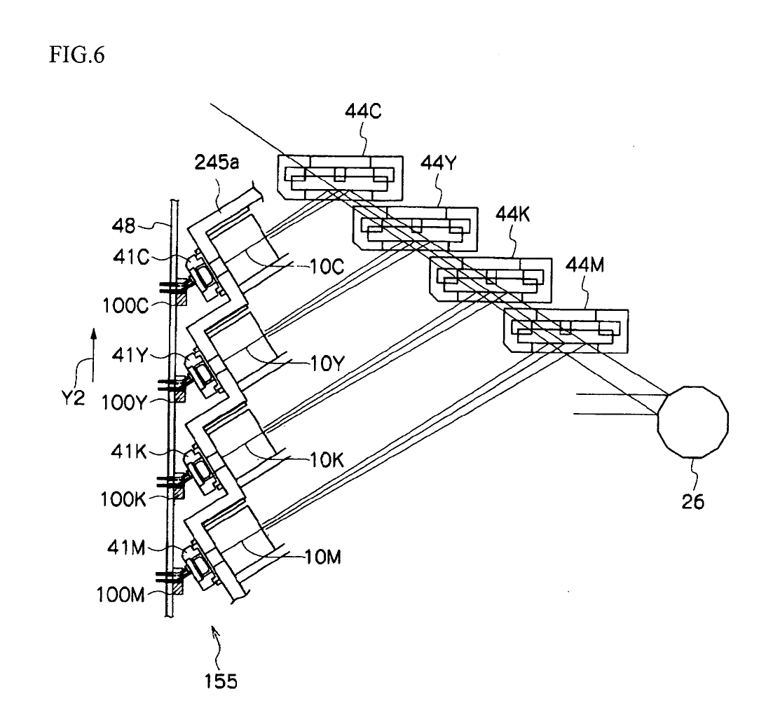

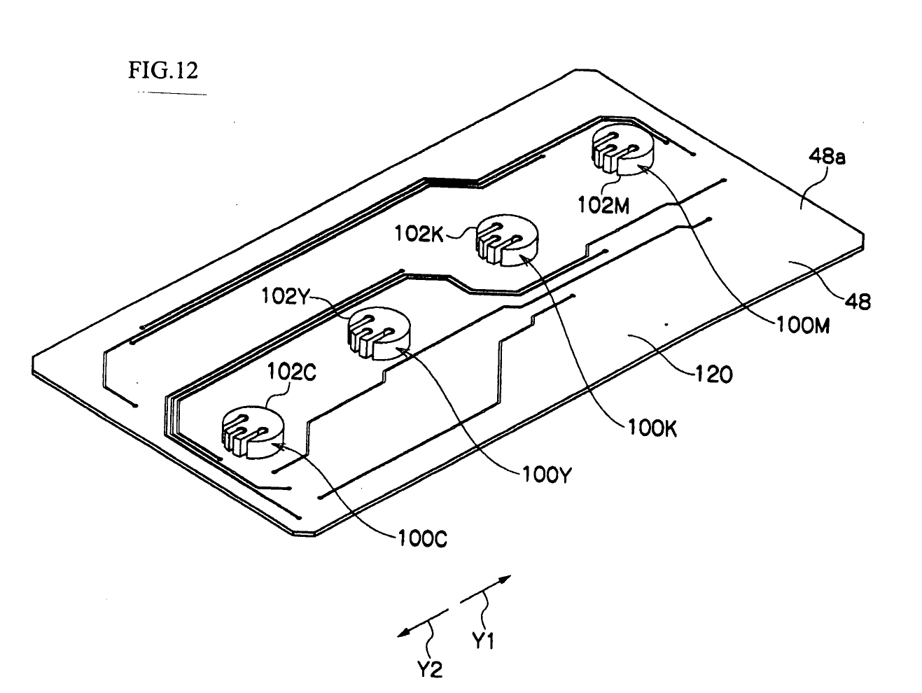

It will be noted that the laser light sources 41Y, 41M, 41C and 41K are connected to a single electric substrate (LD substrate) 48 via sockets 100Y, 100M, 100C and 100K (see FIG. 6 and FIG. 12). The details of the sockets 100Y, 100M, 100C and 100K will be described later.

As shown in FIG. 3, in the first optical system 600, collimator lenses (not shown) corresponding to the respective colors of yellow (Y), magenta (M), cyan (C) and black (K), slits 43Y, 43M, 43C and 43K, first reflection mirror portions 44Y, 44M, 44C and 44K, a first lens system 45, a second reflection mirror 46, a second lens system 47, the rotating polygon mirror 26, the scanning lenses 28, and the folding mirror 29 are disposed in the order of the progression direction of the laser light beams 10Y to 10K generated by the laser light sources 41Y, 41M, 41C and 41K.

The collimator lenses, the slits 43Y, 43M, 43C and 43K, and the first reflection mirror portions 44Y, 44M, 44C and 44K correspond to the respective colors.

The collimator lenses substantially collimate the laser light beams 10Y to 10K from the laser light sources 41Y, 41M, 41C and 41K. The slits 43Y, 43M, 43C and 43K are for regulating the focused state of the laser light beams 10Y to 10K on the photosensitive drums 16, 18, 20 and 22. The first reflection mirror portions 44Y, 44M, 44C and 44K are for reflecting, toward the second reflection mirror 46 shared by the respective colors, the four laser light beams 10Y to 10K from the laser light sources 41Y, 41M, 41C and 41K.

As shown in FIG. 3, the four laser light beams 10Y to 10K reflected by the first reflection mirror portions 44Y, 44M, 44C and 44K pass through the first lens system 45, are reflected by the second reflection mirror 46, thereafter pass through the second lens system 47, and are made incident on the rotating polygon mirror 26. The rotating polygon mirror 26 is rotated at a constant speed by an unillustrated drive source. For this reason, the four laser light beams 10Y to 10K from the second reflection mirror 46 are reflected and defectively scanned in a horizontal direction.

The four laser light beams 10Y to 10K made incident on the rotating polygon mirror 26 are reflectively deflected by reflective deflection surfaces, pass through the group of two scanning lenses 28, and are made incident on the folding mirror 29. The scanning lenses 28 correct the scanning speed of the four laser light beams 10Y to 10K defectively scanned by the rotating polygon mirror 26 and cause the laser light beams 10Y to 10K to be imaged in the vicinity of the photosensitive drums 16, 18, 20 and 22 (see FIG. 2). The folding mirror 29 is for causing the four laser light beams 10Y to 10K to be reflected such that they progress to the second optical system 500 through the window 244 in the boundary portion 243.

As shown in FIG. 2, the second optical system 500 is configured by the split polygon mirror 30, the reflection mirrors 32, and the cylindrical mirrors 34Y, 34M, 34C and 34K that are final mirrors. The four laser light beams 10Y to 10K from the first optical system 600 are split by the split polygon mirror 30 in directions corresponding to the arrangement direction of the photosensitive drums 16, 18, 20 and 22. The four laser light beams 10Y to 10K that have been split are reflected by the corresponding reflection mirrors 32 and guided to the corresponding photosensitive drums 16, 18, 20 and 22 by the cylindrical mirrors 34Y, 34M, 34C and 34K.

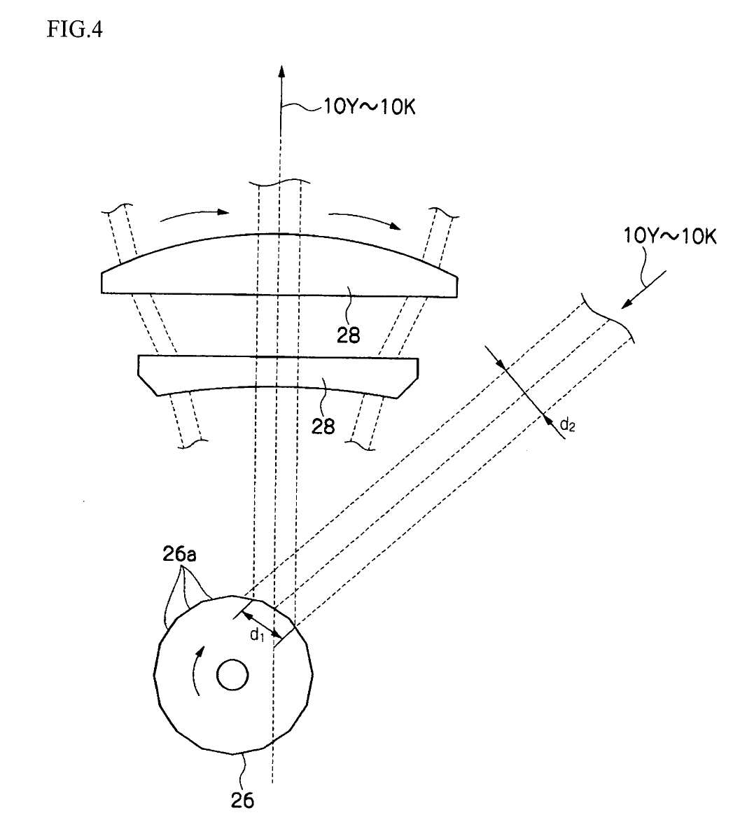

FIG. 4 is a schematic diagram showing the laser light beams 10Y to 10K being reflected in the horizontal direction by the rotating polygon mirror 26.

As shown in FIG. 4, the four laser light beams 10Y to 10K from the second reflection mirror 46 (see FIG. 3) are made incident on reflective deflection surfaces 26a of the rotating polygon mirror 26. Here, the laser light beams 10Y to 10K, which have a beam width d2 that is wider than a width d1 of the reflective deflection surfaces 26a, are made incident on the reflective deflection surfaces 26a. Additionally, some of the laser light beams 10Y to 10K are reflected by the reflective deflection surfaces 26a of the rotating polygon mirror 26 toward the scanning lenses 28 and scanned.

In this manner, in the present exemplary embodiment, an overfilled optical system is employed. In an overfilled optical system, the diameter of the rotating polygon mirror can be made smaller than in an underfilled optical system, so an increase in the diameter size of the rotating polygon mirror can be avoided even when the number of surfaces is increased, and accommodation of high-speed rotation becomes possible because of weight reduction and a reduction in the inertia moment. That is, an overfilled optical system more easily accommodates, and is suited for, instances where the process speed of the image forming apparatus 1 is fast.

FIG. 6 is a schematic configural diagram showing light paths of the laser light beams 10Y to 10K.

As shown in FIG. 6, the laser light beams 10Y to 10K from the laser light sources 41Y, 41M, 41C and 41K progress parallel to each other toward the first reflection mirror portions 44Y, 44M, 44C and 44K. Additionally, the light path lengths from the emission points of the laser light beams 10Y to 10K to the rotating polygon mirror 26 are equal. The laser light beams 10Y to 10K are divergent light, and their divergence angles are mutually the same. For this reason, it is possible to apply them to an overfilled optical system.

Next, the sockets 100Y, 100M, 100C and 100K that connect the laser light sources 41Y, 41M, 41C and 41K to the electric substrate 48 will be described. Because the sockets 100Y, 100M, 100C and 100K all have the same configuration, they will be described without distinguishing between Y, M, C and K.

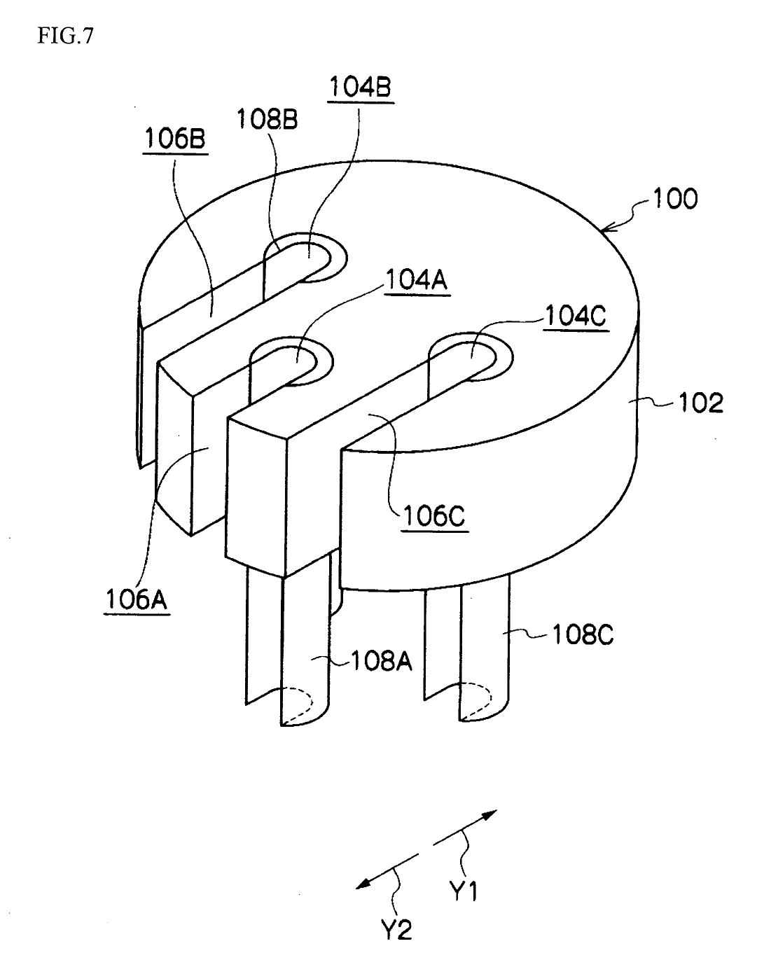

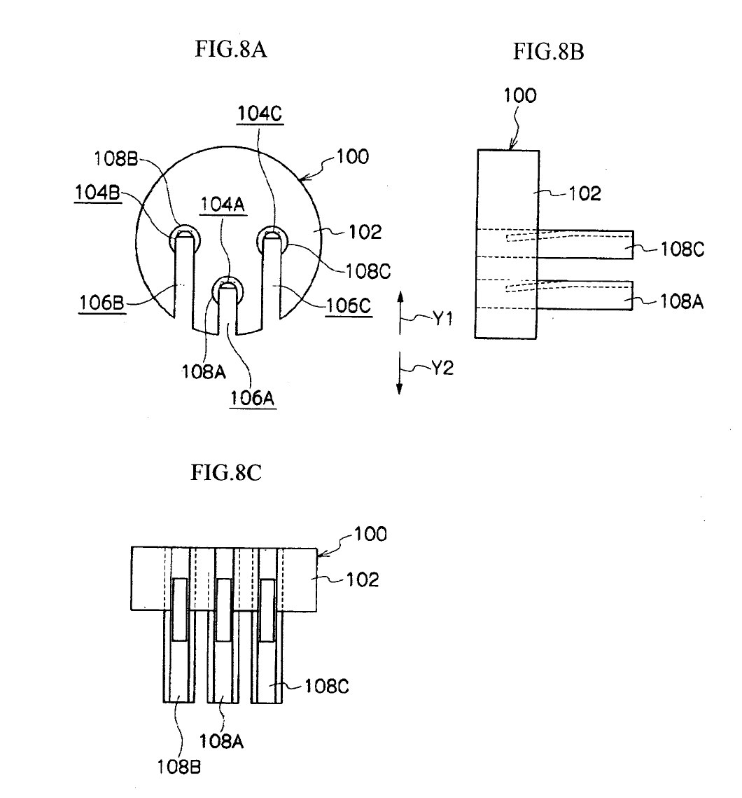

As shown in FIG. 7 and FIGS. 8A to 8C, each of the sockets 100 includes a discoid head portion 102. Three through holes 104A, 104B and 104C are formed in the head portion 102.

The through holes 104A, 104B and 104C are equidistant from each other (see FIG. 8C) when seen in the direction of arrow Y1 (the direction in which later-described pins 61 of the laser light sources 41 are inserted). Further, when seen in plan view, the through holes 104A, 104B and 104C configure an equilateral triangle (the distances between the through holes 104A, 104B and 104C are equal).

Moreover, cut portions 106A, 106B and 106C that connect to the through holes 104A, 104B and 104C in the direction of arrow Yl are formed in the head portion 102. The cut portions 106A, 106B and 106C are parallel to each other. Further, the head portion 102 has an insulating property.

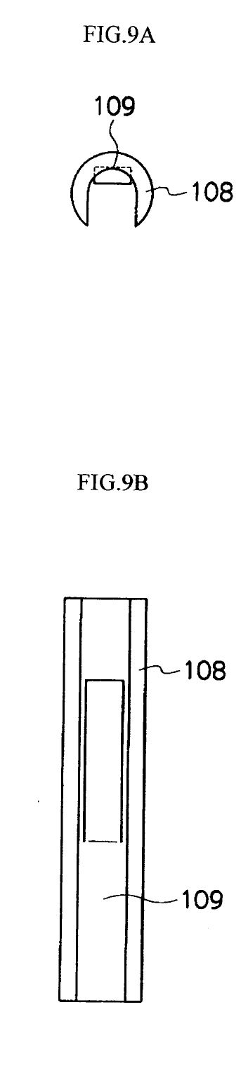

Connection pins 108A, 108B and 108C are inserted into the through holes 104A, 104B and 104C in the head portion 102. The cross sections of the connection pins 108A, 108B and 108C are semicircular (see also FIG. 9A and FIG. 9B). Additionally, the connection pins 108A, 108B and 108C are inserted into the through holes 104A, 104B and 104C in the head portion 102 such that semicircular openings of the connection pins 108A, 108B and 108C coincide with the cut portions 106A, 106B and 106C. One end portion of each of the connection pins 108A, 108B and 108C is inserted as far as substantially the same plane as the upper surface of the head portion 102. Additionally, the other end portions of the connection pins 108A, 108B and 108C project from the undersurface of the head portion 102. It will be noted that the connection pins 108A, 108B and 108C are configured to not escape after they have been inserted into the head portion 102. Further, the connection pins 108A, 108B and 108C comprise a conductive material such as metal.

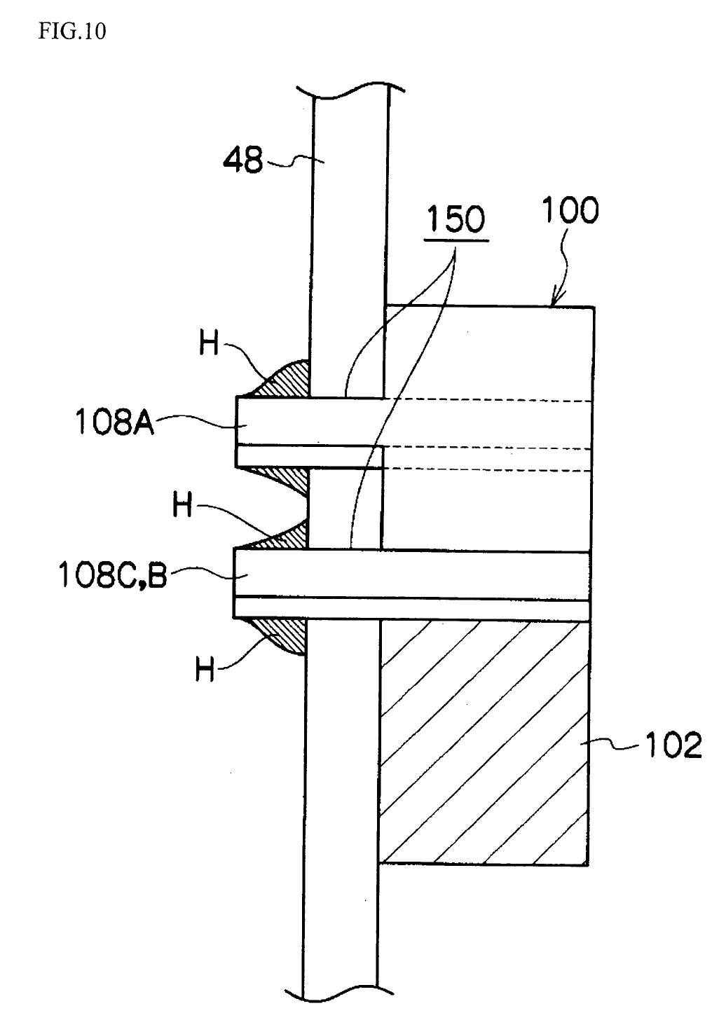

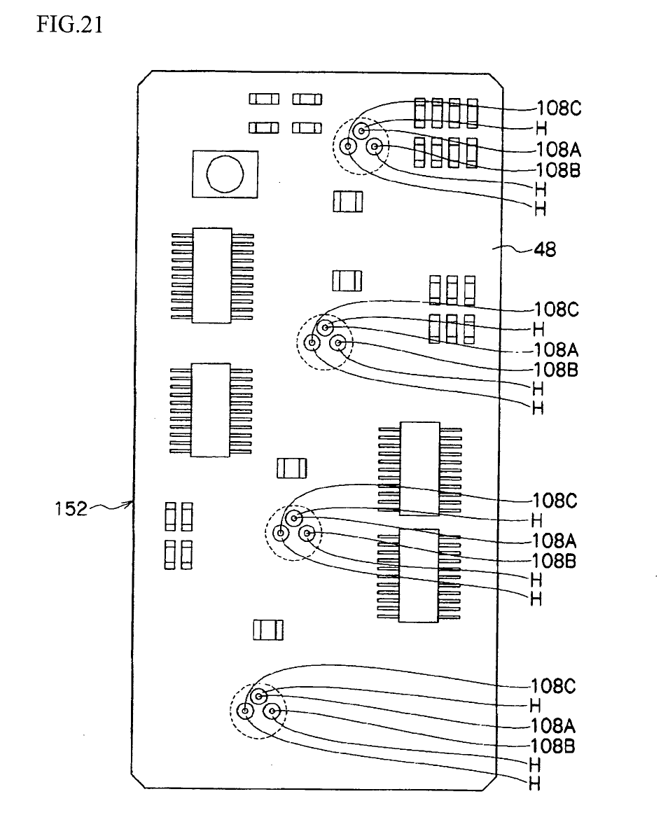

Additionally, as shown in FIG. 10, the connection pins 108A, 108B and 108C of the socket 100 are inserted into attachment holes 150 that penetrate the electric substrate 48, and are connected to the electric substrate 48 by soldering. It will be noted that the solder is represented by letter H (see also FIG. 21, which is a diagram of the side of the electric substrate 48 opposite from the side to which the sockets 100 are connected).

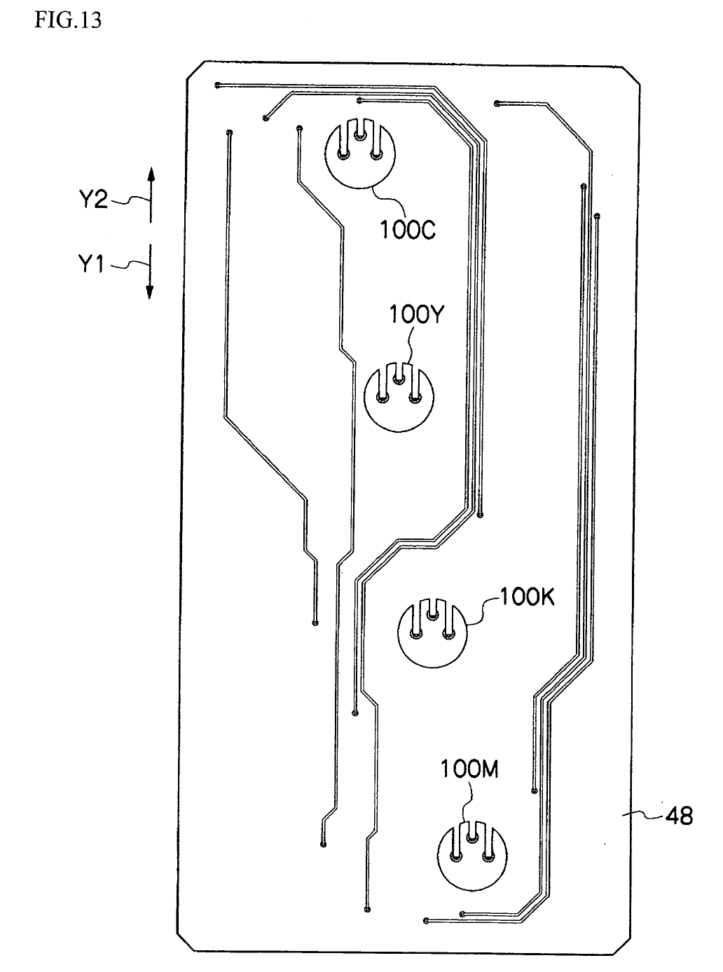

As shown in FIG. 12 and FIG. 13, the four sockets 100Y, 100M, 100C and 100K are connected to the electric substrate 48 in accordance with the arranged positions of the laser light sources 41Y, 41M, 41C and 41K.

Further, as shown in FIG. 21, a drive circuit 152 configured by various electronic parts for driving the laser light sources 41Y, 41M, 41C and 41K (causing to the laser light sources 41Y, 41M, 41C and 41K to emit light) is disposed on the side of the electric substrate 48 opposite from the side to which the sockets 100 are connected.

The attachment portion 245a for attaching the laser light sources 41Y, 41M, 41C and 41K (sometimes these will be referred to below as “the laser light sources 41” without distinguishing between Y, M, C and K) is disposed on the side wall 245 of the optical box 24 shown in FIG. 3. The attachment portion 245a is formed in a stepped shape capable of attaching the laser light sources 41 in a predetermined positional relationship.

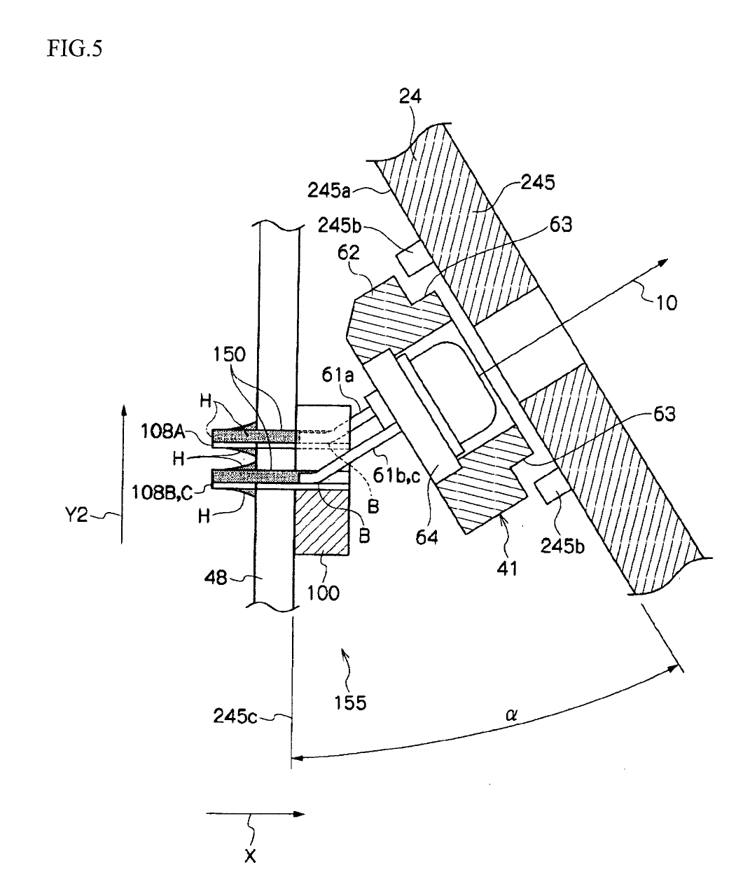

FIG. 5 is a configural diagram partially showing, in an enlarged cross section, the vicinity of the attachment portion 245a to which the laser light sources 41 are attached. Each of the laser light sources 41 is disposed with a light emitting diode (semiconductor laser) 64 and a holder 62 that holds the light emitting diode 64. The light emitting diode 64 includes three pins 61a, 61b and 61c. The pins 61a, 61b and 61c are inserted from the one end portion of each of the connection pins 108A, 108B and 108C of the socket 100 connected to the electric substrate 48. Each of the pins 61a, 61b and 61c is bent in one direction in the middle in the socket 100.

Further, the electric substrate 48 is attached to an outer wall surface 245c (hereinafter called “the attachment surface 245c”) (see FIG. 3 also) of the side wall 245 of the optical box 24.

In this manner, in the optical box 24, the attachment surface 245c of the side wall 245 to which the electric substrate 48 is attached and the attachment portion 245a (reference surface) to which the laser light sources 41 are attached are not mutually parallel but configured to form a predetermined angle α. In other words, the attachment portion 245a extends such that the laser light beams 10 emitted from the laser light sources 41 intersect the normal direction of the electric substrate 48.

Thus, the laser light beams 10 are emitted at the angle α (diagonally) with respect to the electric substrate 48.

Further, projecting positioning portions 245b are disposed on the attachment portion 245a. The holder 62 includes recessed portions 63 that position the holder 62 with respect to the attachment portion 245a by engaging with the positioning portions 245b.

It will be noted that the plural laser light sources 41Y, 41M, 41C and 41K are fixed after the light axes of the laser light beams 10 have been adjusted.

Next, the method of interconnecting the sockets 100 (the electric substrate 48) and the laser light sources 41 will be described.

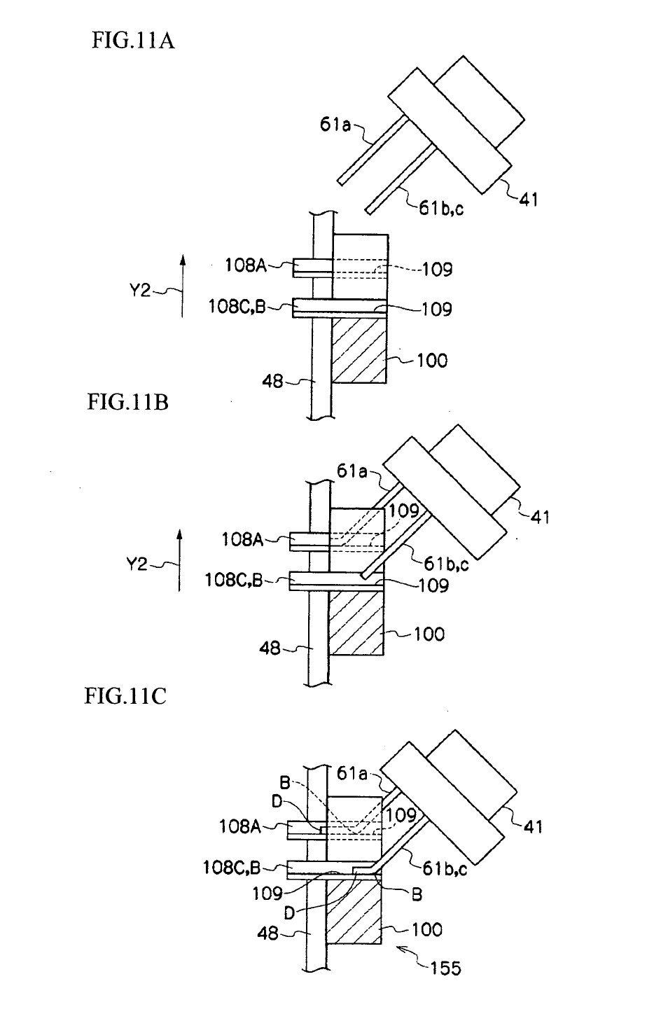

First, as shown in FIG. 11A and as mentioned above, each of the laser light source 41 is attached to the attachment portion 245a (see FIG. 5). It will be noted that the pins 61a, 61b and 61b are not bent prior to the laser light source 41 being attached to the attachment portion 245a.

The electric substrate 48 is slid in the direction of arrow Y2 such that the pins 61a, 61b and 61c are inserted from the cut portions 106A, 106B and 106C (see FIG. 7, etc.) in the sockets 100. It will be noted that arrow Y2 represents the opposite direction of arrow Y1 (see FIG. 7, etc.), and the direction of arrow Y2 and the emission direction of the laser light beams 10 form an angle that becomes the angle α.

As shown in FIG. 11B and FIG. 11C, when the electric substrate 48 is further slid, then the pins 61a, 61b and 61c strike semicircular top portions 109 (see also FIG. 9A and FIG. 9B) of the connection pins 108A, 108B and 108C. When the electric substrate 48 is slid even more, then the pins 61a, 61b and 61c are inserted into the connection pins 108A, 108B and 108C, and the distal end portions of the connection pins 61a, 61b and 61c advance along the top portions 109, whereby the connection pins 61a, 61b and 61c become bent.

It will be noted that although FIGS. 11A to 11C show one of the laser light sources 41 being connected to one of the sockets 100, all four of the laser light sources 41 Y, 41M, 41C and 41K are connected in the same manner and at the same time. That is, all four of the laser light sources 41Y, 41M, 41C and 41K are connected to the electric substrate 48 via the sockets 100Y, 100M, 100C and 100K by one-time action of sliding the electric substrate 48.

Then, the electric substrate 48 is fixed to the attachment surface 245c, and the solder H is applied from the other end portions of the connection pins 108A, 108B and 108C such that the connection pins 108A, 108B and 108C and the pins 61a, 61b and 61c are fixed to each other by the solder H. It will be noted that the solder H enters gaps between the connection pins 108A, 108 and 108C and the pins 61a, 61b and 61c by the capillary phenomenon.

Each of the three pins 61a, 61b and 61c has one bending point B, and when the pins 6 1a, 61 b and 61 c are bent in the same direction at the bending points B, portions D further toward the distal ends than the bending points B of the pins 61a, 61b and 61c become mutually parallel, and the portions D that are adjacent to each other become substantially equidistant from each other.

Further, a light source device 155 comprises the laser light sources 41 connected to the sockets 100 of the electric substrate 48.

Next, the action of the present exemplary embodiment will be described.

The plural laser light sources 41Y, 41M, 41C and 41K can easily be connected to the single electric substrate 48 via the sockets 100. For this reason, it is easy to closely dispose the laser light sources 41Y, 41M, 41C and 41K.

Further, because the laser light sources 41Y, 41M, 41C and 41K and the electric substrate 48 are not directly soldered, it is possible to easily replace just the laser light sources 41Y, 41M, 41C and 41K.

Further, the electric substrate 48 is slid such that the pins 61a, 61b and 61c of the laser light sources 41Y, 41M, 41C and 41K are inserted into the connection pins 108A, 108B and 108C of the sockets 100, whereby the pins 61a, 61b and 61c advance along the connection pins 108A, 108B and 108C and become bent. Thus, the plural laser light sources 41Y, 41M, 41C and 41K, where the light axes of the laser light beams 10 have been adjusted beforehand and fixed, can be easily connected to the single electric substrate 48 such that the light beams 10 have the angle α with respect to the electric substrate 48.

Each of the three pins 61a, 61b and 61c has one bending point B. When the pins 61a, 61b and 61c are bent in the same direction at the bending points B in this manner, the portions D further toward the distal ends than the bending points B of the pins 61a, 61b and 61c become mutually parallel, and the portions D that are adjacent to each other become substantially equidistant from each other. Consequently, the pins can be safely connected without contact between terminals. Further, disposing the soldered portions of the electric substrate can be done easily.

Further, the attachment surface 245c to which the electric substrate 48 is attached and the attachment portion 245a (reference surface) to which the laser light sources 41 are attached are not mutually parallel but configured to form the predetermined angle α (in other words, the attachment portion 245a extends such that the laser light beams 10 emitted from the laser light sources 41 intersect the normal direction of the electric substrate 48). Thus, because the angle between the attachment surface 245c and the attachment portion 245a can be arbitrarily set, it becomes possible to use the electric substrate 48 also in an optical scanning device where the laser light beams 10 have different angles and its versatility can be improved.

Moreover, the laser light sources 41 can be connected to the single electric substrate 48 even when the laser light beams 10Y, 10M, 10C and 10K emitted from the plural laser light sources 41Y, 41M, 41C and 41K are given respectively different angles.

Further, the electric substrate 48 can be disposed parallel to the side wall (outer peripheral surface, outer peripheral wall) 245 of the optical box 24 and the projected area can be reduced, so the widths of the optical scanning device 12 and the image forming apparatus 1 can be reduced.

Next, modifications of the sockets 100 will be described.

First, a first modification will be described.

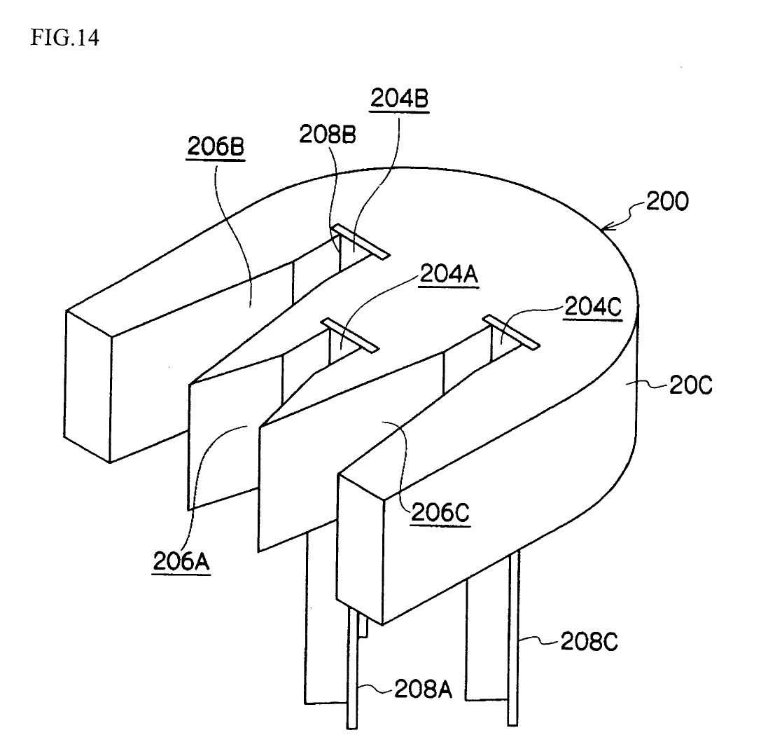

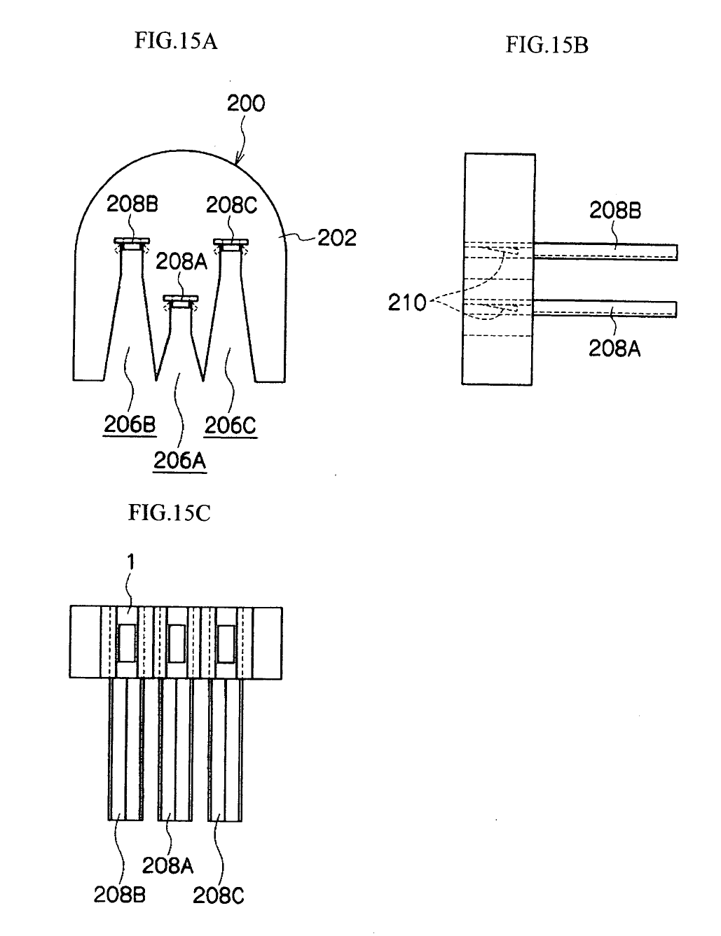

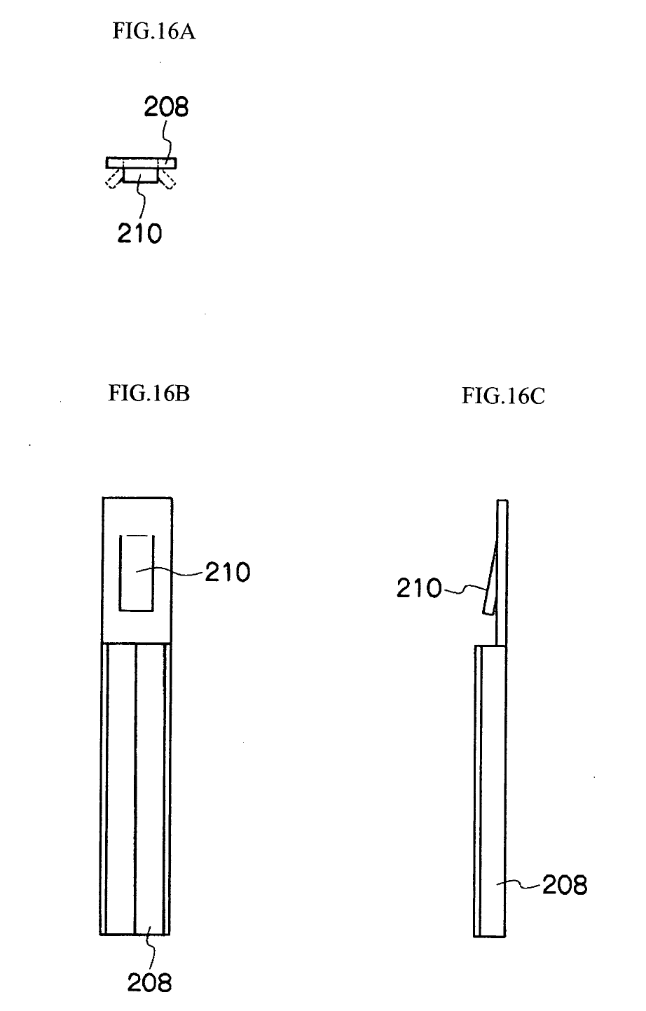

As shown in FIG. 14, FIGS. 15A to 15C and FIGS. 16A to 16C, in a socket 200 of the first modification, the cross sections of connection pins 208A, 208B and 208C are V-shaped. Additionally, the connection pins 208A, 208B and 208C are inserted into through holes 204A, 204B and 204C in a head portion 202 such that their V-shaped openings coincide with cut portions 206A, 206B and 206C. It will be noted that the cut portions 206A, 206B and 206C have V shapes whose open sides are wide.

One end portion of each of the connection pins 208A, 208B and 208C is inserted as far as substantially the same plane as the upper surface of a head portion 202. Additionally, the other end portions of the connection pins 208A, 208B and 208C project from the undersurface of the head portion 202. Further, the connection pins 208A, 208B and 208C are configured to not escape after they have been inserted into the head portion 202. Further, the connection pins 208A, 208B and 208C comprise a conductive material such as metal.

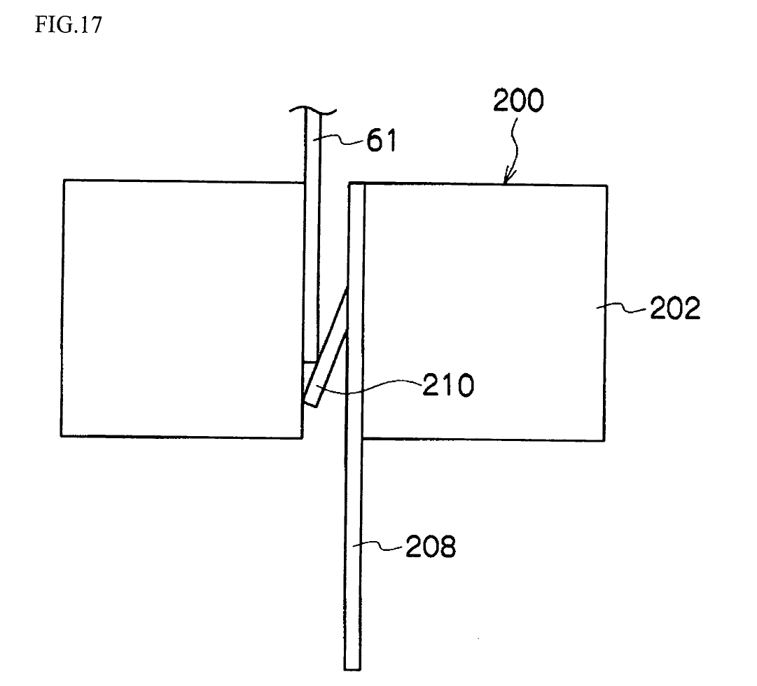

Moreover, as shown in FIGS. 16A to 16C and FIG. 17, plate springs 210 serving as a holding member that holds the pins 61 are disposed on the portion of the connection pins 208 into which the pins 61 are inserted. Additionally, the pins 61 are held in the connection pins 208 by the plate springs 210.

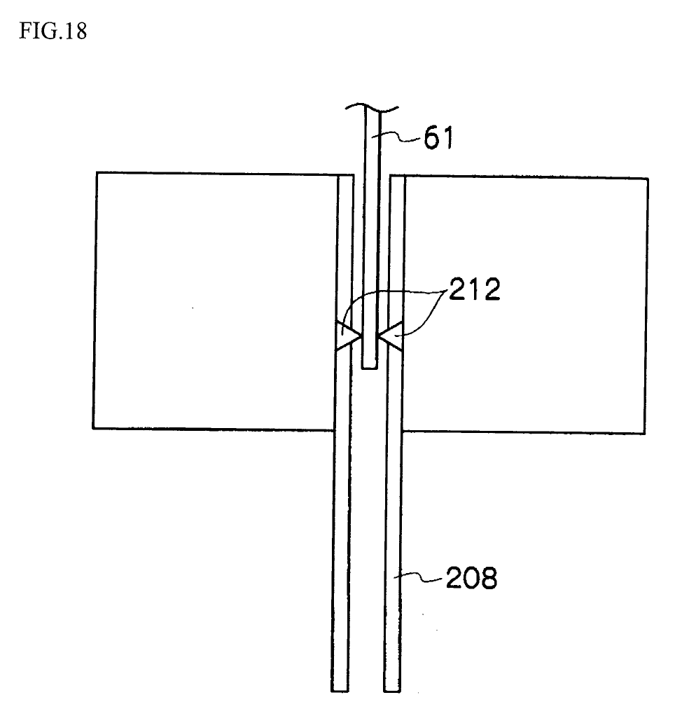

It will be noted that the pins 61 may also be held by holding members other than the plate springs 210. For example, as shown in FIG. 18, the pins 61 may be held by an aperture portion 212.

The socket 200 of the first modification also exhibits the same action, but the pins 61 are reliably held in the connection pins 208 by the plate springs 210. Further, because the cut portions 206A, 206B and 206C have V shapes whose open sides are wide, workability is good when sliding the electric substrate 48 such that the pins 61 are inserted into the connection pins 208A, 208B and 208C.

Next, a second modification will be described.

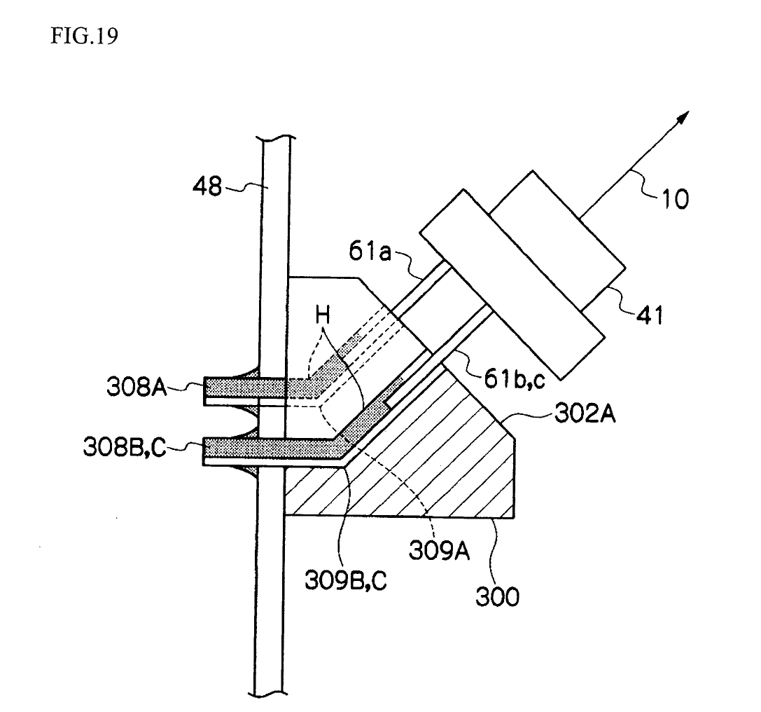

As shown in FIG. 19, in a socket 300 of the second medication, an upper surface 302A of a head portion 302 is formed so as to be orthogonal to the laser light beam 10, and connection pins 308A, 308B and 308C are bent in the middle.

Specifically, one end portion side of each of the connection pins 308A, 308B and 308C (the sides into which the pins 61 are inserted) is in the same direction as the laser light beam 10, but the other end portion sides (the sides inserted into the substrate) from bent portions 309A, 309B and 309C are bent in the same direction as the direction orthogonal to the electric substrate 48.

Next, a third modification will be described.

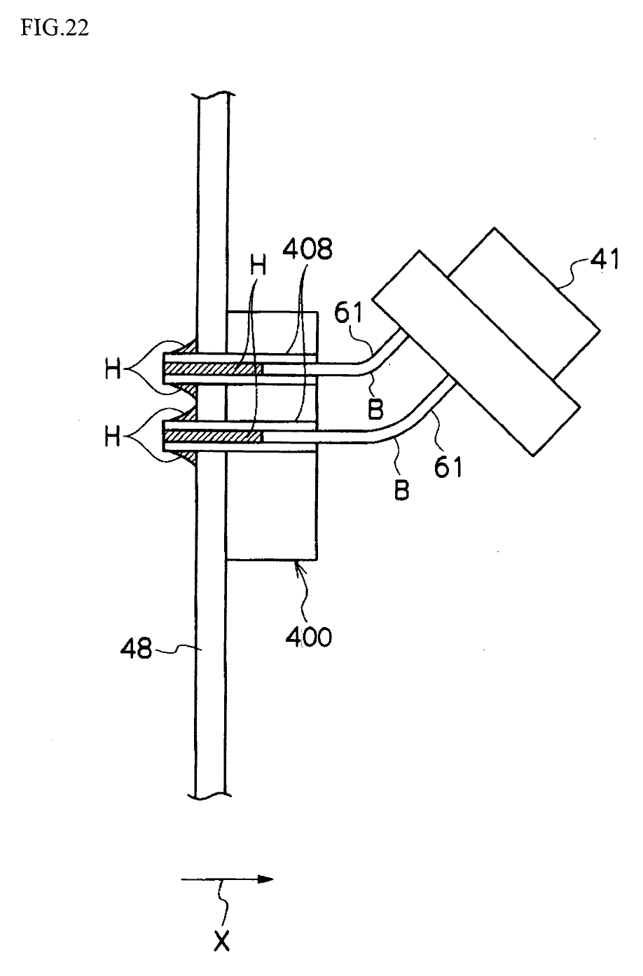

As shown in FIG. 22, in a socket 400 of the third modification, connection pins 408 have circular cylinder shapes. Additionally, the pins 61 of the laser light source 41 are connected to the socket 400 in a state where they have been bent beforehand.

In this configuration also, the solder H is applied from the other end portion sides of the connection pins 408 penetrating the electric substrate 48, so that the pins 61 of the laser light source 41 and the connection pins 408 can be soldered to each other. Further, because the laser light source 41 and the electric substrate 48 are not directly soldered, it is possible to easily replace just the laser light source 41 even after the laser light source 41 and the electric substrate 48 have been connected.

An example of the method of bending the pins 61 of the light source 41 beforehand will be described below.

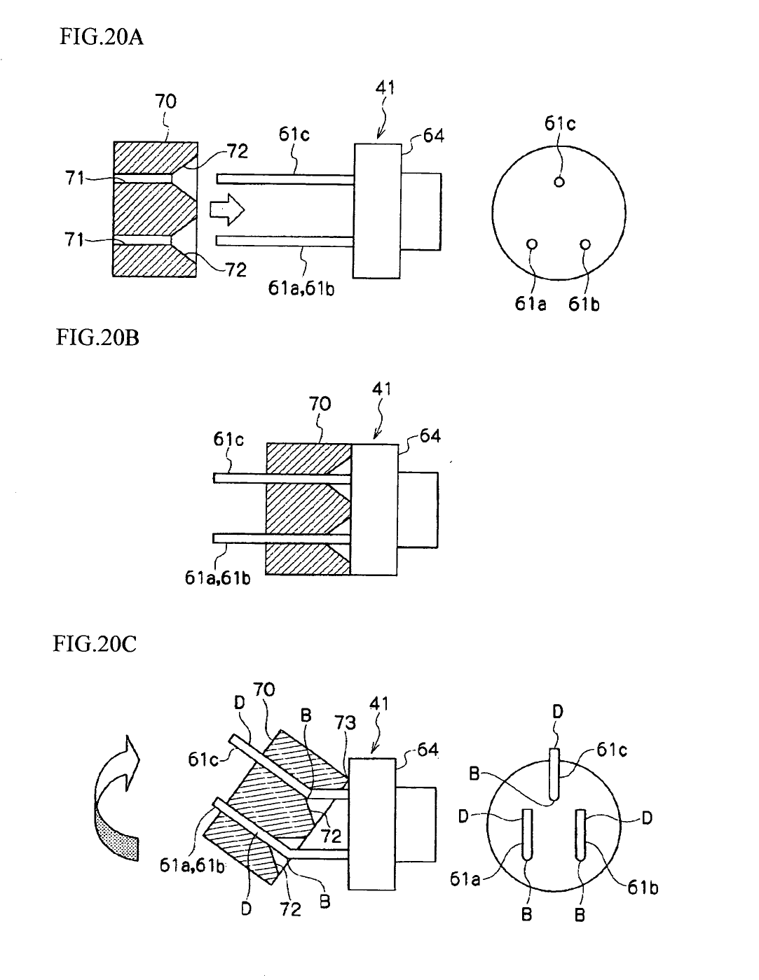

FIG. 20A to FIG. 20C show, in a time series, the process of bending the pins 61a, 61b and 61c of the light emitting diode 64 of the laser light source 41. In FIG. 20A to FIG. 20C, a bending jig 70 is shown in cross section for convenience of description.

As shown in FIG. 20A to FIG. 20C, the bending of the three pins 61a, 61b and 61c is performed using the bending jig 70. The bending jig 70 includes three through holes 71 formed to allow the pins 61a, 61b and 61c to pass therethrough and chamfered receiving portions 72 that are disposed around the through holes 71 and receive the pins 61a, 61b and 61c to facilitate insertion of the pins 61a, 61b and 61c into the through holes 71. The relative positional relationship of the three through holes 71 corresponds to the relative positional relationship of the three pins of the light emitting diode 64.

As shown in FIG. 20A, the bending jig 70 is moved toward the light emitting diode 64 such that the pins 61a, 61b and 61c are received by the receiving portions 72 of the bending jig 70.

Then, as shown in FIG. 20B, the pins 61a, 61b and 61c are inserted into the through holes 71 in the bending jig 70 to bring the bending jig 70 into contact with the light emitting diode 64.

Thereafter, as shown in FIG. 20C, the bending jig 70 is rotated in one direction about a corner portion 73 that contacts the light emitting diode 64 such that the pins 61a and 61b bend toward the pin 61c. Thus, a bending moment acts on each of the three pins 61a, 61b and 61c, and the three pins 61a, 61b and 61c are bent in one direction. That is, the bending points B of the three pins 61a, 61b and 61c are positioned in the middle in the longitudinal direction of the pins. Further, there is one bending point B in each of the pins 61a, 61b and 61c. When the pins 61a, 61b and 61c are bent in the same direction at the bending points B in this manner, the portions D further toward the distal ends than the bending points B of the pins 61a, 61b and 61c become mutually parallel, and the portions D that are adjacent to each other become substantially equidistant from each other.

It will be noted that in the state shown in FIG. 20C, the pin 61c is bent along the receiving portion 72, and the pins 61a, 61b and 61c can escape from the bending jig 70. Further, because the pins 61a, 61b and 61c are bent in the same direction, contact with other pins can be prevented.

Then, as shown in FIG. 22, the laser light source 41 disposed with the light emitting diode 64 whose three pins 61a, 61b and 61c have been bent is attached to the attachment surface 245a (see FIG. 5), the electric substrate 48 is moved in the direction of arrow X (the direction orthogonal to the flat surface of the electric substrate 48), the pins 61 are inserted into the connection pins 408, and the laser light source 41 and the electric substrate 48 are connected.

It is an object of the present invention to facilitate the work of connecting a light source to an electric substrate.

According to a first aspect of the present invention, there is provided a connection member that connects an electric substrate and a light source that emits a light beam, the connection member comprising: a light source terminal insertion portion into which a light source terminal of the light source is inserted from one end portion side and having another end portion side that penetrates the electric substrate.

In the connection member of the first aspect, the other end portion of the light source terminal insertion portion is passed through the electric substrate and soldered, whereby the connection member connects to the electric substrate. Further, the light source terminal of the light source is inserted from the one end portion side of the light source terminal insertion portion. Thus, solder is applied from the other end portion side penetrating the electric substrate, and the light source terminal and the light source terminal insertion portion can be soldered to each other. Consequently, the work of connecting the light source to the electric substrate is easy.

Further, because the light source and the electric substrate are not directly soldered, just the light source can be easily replaced even after the light source and the electric substrate have been connected to each other.

According to a second aspect of the present invention, there is provided an electric substrate comprising: a connection member that connects an electric substrate and a light source that emits a light beam, the connection member including a light source terminal insertion portion into which a light source terminal of the light source is inserted from one end portion side and having another end portion side that penetrates the electric substrate; and a drive circuit that drives the light source.

Because the electric substrate of the second aspect is disposed with the connection member, the light source can be easily connected to the electric substrate.

According to a third aspect of the present invention, the electric substrate is provided with plural connection members.

In the electric substrate of the third aspect, plural light sources can be easily connected to the electric substrate. Further, because plural light sources can be connected to the same electric substrate, it is easy to closely dispose the light sources.

According to a fourth aspect of the present invention, there is provided a light source device comprising: any electric substrate of the second or the third aspect; and the light source having the light source terminal inserted into the light source terminal insertion portion of the connection member and which is connected to the electric substrate.

In the light source device of the fourth aspect, the ease with which the light source device can be assembled is good because the light source can be easily connected to the electric substrate.

According to a fifth aspect of the present invention, in the light source device of the fourth aspect, the light source terminal is bent before being inserted into the light source terminal insertion portion of the connection member.

In the light source device of the fifth aspect, it becomes possible for the light beam emitted from the light source to be emitted diagonally with respect to the electric substrate because the light source terminal is bent before being inserted into the light source terminal insertion portion of the connection member.

According to a sixth aspect of the present invention, in the light source device of the fifth aspect, the light source is provided with a plurality of the light source terminals, and the plural light source terminals are bent in the same direction such that they are aligned in parallel and, of the bent portions of the light source terminals, the portions that are adjacent to each other are substantially equidistant from each other.

In the light source device of the sixth aspect, the plural light source terminals are bent in the same direction such that they are mutually parallel and, of the bent portions of the light source terminals, the portions that are adjacent to each other are substantially equidistant from each other. Thus, the light source terminals can be safely connected without contact between terminals. Further, disposing the soldered portions of the electric substrate can be done easily.

According to a seventh aspect of the present invention, there is provided a connection member that connects an electric substrate and a light source that emits a light beam, the connection member comprising: a light source terminal insertion portion into which a light source terminal of the light source is inserted and which bends the light source terminal when the light source terminal is inserted therein.

In the connection member of the seventh aspect, the light source can be easily connected to the electric substrate such that the light beam is emitted diagonally with respect to the electric substrate because the connection member bends the light source terminal when the light source terminal of the light source is inserted into the light source terminal insertion portion.

Further, because the light source and the electric substrate are not directly soldered, just the light source can be easily replaced even after the light source and the electric substrate have been connected to each other.

According to an eighth aspect of the present invention, the connection member of the seventh aspect is configured such that the light source terminal of the light source is capable of being inserted into the light source terminal insertion portion when the electric substrate is slid in a diagonal direction with respect to the light beam, and the connection member bends the light source terminal along the light source terminal insertion portion when the electric substrate is slid in the diagonal direction with respect to the light beam and the light source terminal is inserted into the light source terminal insertion portion.

In the connection member of the eighth aspect, when the electric substrate is slid in a diagonal direction with respect to the light beam and the light source terminal of the light source is inserted into the light source terminal insertion portion, the connection member bends the light source terminal along the light source terminal insertion portion. Thus, the light source can be easily connected to the electric substrate such that the light beam is emitted diagonally with respect to the electric substrate.

According to a ninth aspect of the present invention, in any connection member of the seventh or the eighth aspect, the cross section of the light source terminal insertion portion is V-shaped.

In the connection member of the ninth aspect, the light source terminal is guided by its V-shaped distal end portion, progresses along the light source terminal insertion portion, and bends.

According to a tenth aspect of the present invention, in any connection member of the seventh or the eighth aspect, the cross section of the light source terminal insertion portion is semicircular.

In the connection member of the tenth aspect, the light source terminal is guided by its semicircular top portion, progresses along the light source terminal insertion portion, and bends.

According to an eleventh aspect of the present invention, there is provided an electric substrate comprising: a connection member that connects an electric substrate and a light source that emits a light beam, the connection member including a light source terminal insertion portion into which a light source terminal of the light source is inserted and which bends the light source terminal when the light source terminal is inserted therein; and a drive circuit that drives the light source.

Because the electric substrate of the eleventh aspect is disposed with the connection member, the light source can be easily connected to the electric substrate.

According to a twelfth aspect of the present invention, the electric substrate of the eleventh aspect is disposed with plural connection members.

In the electric substrate of the twelfth aspect, plural light sources can be easily connected to the electric substrate. Further, because plural light sources can be connected to the same electric substrate, it is easy to closely dispose the light sources.

According to a thirteenth aspect of the present invention, there is provided a light source device comprising: any electric substrate of the eleventh or the twelfth aspect; and the light source having the light source terminal inserted into the light source terminal insertion portion of the connection member and which is connected to the electric substrate.

In the light source device of the thirteenth aspect, the ease with which the light source device can be assembled is good because the light source can be easily connected to the electric substrate.

According to a fourteenth aspect of the present invention, in the light source device of the thirteenth aspect, the light source is provided with a plurality of the light source terminals, and the light source terminal insertion portion of the connection member bends the plural light source terminals in one direction such that they are aligned in parallel and, of the bent portions of the light source terminals, the portions that are adjacent to each other are substantially equidistant from each other.

In the light source device of the fourteenth aspect, the light source terminal insertion portion of the connection member bends the plural light source terminals in one direction such that they become mutually parallel and, of the bent portions of the light source terminals, the portions that are adjacent to each other are substantially equidistant from each other. Thus, the light source terminals can be safely connected without contact between terminals. Further, disposing the soldered portions of the electric substrate can be done easily.

According to a fifteenth aspect of the present invention, there is provided an optical scanning device comprising: any light source device of the fourth to the sixth aspects; and an optical box that houses the light source device, wherein the optical box includes an attachment surface to which the electric substrate of the light source device is attached and a reference surface to which the light source of the light source device is attached, and the reference surface extends in a direction intersecting the attachment surface.

According to a sixteenth aspect of the present invention, there is provided an optical scanning device comprising: any light source device of the thirteenth or the fourteenth aspect; and an optical box that houses the light source device, wherein the optical box includes an attachment surface to which the electric substrate of the light source device is attached and a reference surface to which the light source of the light source device is attached, and the reference surface extends in a direction intersecting the attachment surface.

In the optical scanning devices of the fifteenth and the sixteenth aspects, the attachment surface of the optical box to which the electric substrate configuring the light source device is attached extends in a direction intersecting the reference surface to which the light source configuring the light source device is attached.

Thus, because the angle between the reference surface and the attachment surface can be arbitrarily set, it becomes possible to use the substrate also in an optical scanning device where the light beams have different angles and its versatility can be improved. Further, a single electric substrate can be shared even when light beams emitted from plural light sources are given respectively different angles.

Moreover, the electric substrate can be disposed parallel to the side wall of the optical box and the projected area can be reduced, so the width of the optical scanning device can be reduced.

Further, because the connection member is configured to bend the light source terminal when the light source terminal of the light source is inserted into the light source terminal insertion portion, the optical scanning device can be easily assembled without having to bend the light source terminal of the light source beforehand.

According to a seventeenth aspect of the present invention, there is provided an image forming apparatus that forms an image by developing an electrostatic latent image formed on an image carrier, the image forming apparatus comprising: any light source device of the fourth to the sixth aspects; and an optical box that houses the light source device, wherein the optical box includes a reference surface to which the light source of the light source device is attached, and the reference surface extends such that the light beam emitted from the light source intersects a normal direction of the electric substrate of the light source device.

According to a eighteenth aspect of the present invention, there is provided an image forming apparatus that forms an image by developing an electrostatic latent image formed on an image carrier, the image forming apparatus comprising: any light source device of the thirteenth or the fourteenth aspect; and an optical box that houses the light source device, wherein the optical box includes a reference surface to which the light source of the light source device is attached, and the reference surface extends such that the light beam emitted from the light source intersects a normal direction of the electric substrate of the light source device.

In the image forming apparatuses of the seventeenth and the eighteenth aspects, the reference surface to which the light source configuring the light source device is attached extends such that the light beam emitted from the light source intersects a normal direction of the electric substrate configuring the light source device.

Thus, because the angle between the reference surface and the electric substrate can be arbitrarily set, it becomes possible to use the substrate also in an optical scanning device where the light beams have different angles and its versatility can be improved. Further, a single electric substrate can be shared even when light beams emitted from plural light sources are given respectively different angles.

Moreover, the electric substrate can be disposed parallel to the side wall of the optical box and the projected area can be reduced, so the width of the image forming apparatus can be reduced.

Further, because the connection member is configured to bend the light source terminal when the light source terminal of the light source is inserted into the light source terminal insertion portion, the image forming apparatus can be easily assembled without having to bend the light source terminal of the light source beforehand.

As described above, according to the present invention, the work of connecting a light source to an electric substrate becomes easier.

It will be noted that the present invention is not limited to the preceding exemplary embodiment.

For example, in the exemplary embodiment and the first modification, the socket is configured such that the pins of the laser light source are inserted into one end side of each of the connection pins, and the other end sides of the connection pins penetrate the electric substrate and are soldered. However, the socket may also be configured such that the portions into which the pins of the laser light source are inserted and the portions that penetrate the electric substrate and are soldered are separate members. In this configuration also, the pins bend when the pins of the laser light source are inserted into the socket, so the laser light source and the electric substrate can be easily connected.

The foregoing descriptions of the exemplary embodiments of the present invention have been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A connection member that connects an electric substrate and a light source that emits a light beam, the connection member comprising:
a light source terminal insertion portion into which a light source terminal of the light source is inserted from one end portion side and having another end portion side that penetrates the electric substrate.

2. An electric substrate comprising:
a connection member that connects an electric substrate and a light source that emits a light beam, the connection member including a light source terminal insertion portion into which a light source terminal of the light source is inserted from one end portion side and having another end portion side that penetrates the electric substrate; and
a drive circuit that drives the light source.

3. The electric substrate of claim 2, wherein the electric substrate is provided with a plurality of the connection members.

4. A light source device comprising:
the electric substrate of claim 2; and
the light source having the light source terminal inserted into the light source terminal insertion portion of the connection member and which is connected to the electric substrate.

5. The light source device of claim 4, wherein the light source terminal is bent before being inserted into the light source terminal insertion portion of the connection member.

6. The light source device of claim 5, wherein
the light source is provided with a plurality of the light source terminals, and
the plurality of the light source terminals are bent in the same direction such that they are aligned in parallel and, of the bent portions of the light source terminals, the portions that are adjacent to each other are substantially equidistant from each other.

7. A connection member that connects an electric substrate and a light source that emits a light beam, the connection member comprising:
a light source terminal insertion portion into which a light source terminal of the light source is inserted and which bends the light source terminal when the light source terminal is inserted therein.

8. The connection member of claim 7, wherein
the connection member is configured such that the light source terminal of the light source is capable of being inserted into the light source terminal insertion portion when the electric substrate is slid in a diagonal direction with respect to the light beam, and
the connection member bends the light source terminal along the light source terminal insertion portion when the electric substrate is slid in the diagonal direction with respect to the light beam and the light source terminal is inserted into the light source terminal insertion portion.

9. The connection member of claim 7, wherein the cross section of the light source terminal insertion portion is V-shaped.

10. The connection member of claim 7, wherein the cross section of the light source terminal insertion portion is semicircular.

11. An electric substrate comprising:
a connection member that connects an electric substrate and a light source that emits a light beam, the connection member including a light source terminal insertion portion into which a light source terminal of the light source is inserted and which bends the light source terminal when the light source terminal is inserted therein; and
a drive circuit that drives the light source.

12. The electric substrate of claim 11, wherein the electric substrate is disposed with a plurality of the connection members.

13. A light source device comprising:
the electric substrate of claim 11; and
the light source having the light source terminal inserted into the light source terminal insertion portion of the connection member and which is connected to the electric substrate.

14. The light source device of claim 13, wherein
the light source is provided with a plurality of the light source terminals, and
the light source terminal insertion portion of the connection member bends the plurality of the light source terminals in one direction such that they are aligned in parallel and, of the bent portions of the light source terminals, the portions that are adjacent to each other are substantially equidistant from each other.

15. An optical scanning device comprising:
the light source device of claim 4; and
an optical box that houses the light source device,
wherein the optical box includes an attachment surface to which the electric substrate of the light source device is attached and a reference surface to which the light source of the light source device is attached, and
the reference surface extends in a direction intersecting the attachment surface.

16. An optical scanning device comprising:
the light source device of claim 13; and
an optical box that houses the light source device,
wherein the optical box includes an attachment surface to which the electric substrate of the light source device is attached and a reference surface to which the light source of the light source device is attached, and
the reference surface extends in a direction intersecting the attachment surface.

17. An image forming apparatus that forms an image by developing an electrostatic latent image formed on an image carrier, the image forming apparatus comprising:
the light source device of claim 4; and
an optical box that houses the light source device,
wherein the optical box includes a reference surface to which the light source of the light source device is attached, and
the reference surface extends such that the light beam emitted from the light source intersects a normal direction of the electric substrate of the light source device.

18. An image forming apparatus that forms an image by developing an electrostatic latent image formed on an image carrier, the image forming apparatus comprising:
the light source device of claim 13; and
an optical box that houses the light source device,
wherein the optical box includes a reference surface to which the light source of the light source device is attached, and
the reference surface extends such that the light beam emitted from the light source intersects a normal direction of the electric substrate of the light source device.
